(19) United States
(12) Patent Application Publication
(10) Pub. No.: US 2009/0070408 A1
(43) Pub. Date: Mar. 12, 2009

(54) APPARATUS AND METHOD FOR MANAGING DELIVERY OF MEDIA CONTENT

(75) Inventor: SCOTT WHITE, AUSTIN, TX (US)

Correspondence Address: AKERMAN SENTERFITT, P.O. BOX 3188, WEST PALM BEACH, FL, 33402-3188, US

(73) Assignee: AT&T KNOWLEDGE VENTURES, L.P., RENO, NV (US)

(21) Appl. No.: 11/851,452

(22) Filed: Sep. 7, 2007

(51) Int. Cl. G06F 15/16

(52) U.S. Cl. 709/203

(57) ABSTRACT

A system that incorporates teachings of the present disclosure may include, for example, a set top box having a controller to receive primary multimedia content from available multimedia content where a determination of the primary multimedia content is based at least in part on monitored user activity associated with the set top box, store the primary multimedia content, and present the primary multimedia content in response to a request from a user. Other embodiments are disclosed.

### FIELD OF THE DISCLOSURE

The present disclosure relates generally to communication services and more specifically to an apparatus and method for managing the delivery of media content.

### BACKGROUND

Set top boxes (STBs) can provide presentation of media programming and content. This content can be downloaded to an STB during late evenings so that it is ready on demand for a user. However, STBs are limited by hardware constraints and so the amount of the content that can be available on demand to a user at a given time is limited.

### BRIEF DESCRIPTION OF THE DRAWINGS

FIGS. 1-3 depict exemplary embodiments of communication systems;

FIG. 4 depicts an exemplary method operating in portions of the communication systems; and

FIG. 5 is a diagrammatic representation of a machine in the form of a computer system within which a set of instructions, when executed, may cause the machine to perform any one or more of the methodologies discussed herein.

### DETAILED DESCRIPTION

In one embodiment of the present disclosure, a computer-readable storage medium can have computer instructions for monitoring user activity associated with a set top box, determining primary multimedia content and secondary multimedia content from available multimedia content based at least in part on the user activity, transmitting the primary multimedia content to the set top box for storage therein, and providing the set top box with selective access to the secondary multimedia content from a remote source.

In one embodiment of the present disclosure, a server can have a controller to monitor user activity associated with a set top box, determine primary multimedia content from available multimedia content based at least in part on the user activity, and transmit the primary multimedia content to the set top box for storage therein.

In one embodiment of the present disclosure, a set top box can have a controller to receive primary multimedia content from available multimedia content where a determination of the primary multimedia content is based at least in part on monitored user activity associated with the set top box, store the primary multimedia content, and present the primary multimedia content in response to a request from a user.

In one embodiment of the present disclosure, a method can involve monitoring user activity associated with a set top box, determining primary and secondary multimedia content based at least in part on the user activity, transmitting the primary multimedia content to the set top box for storage therein, and providing the set top box with selective access to the secondary multimedia content from a remote source.

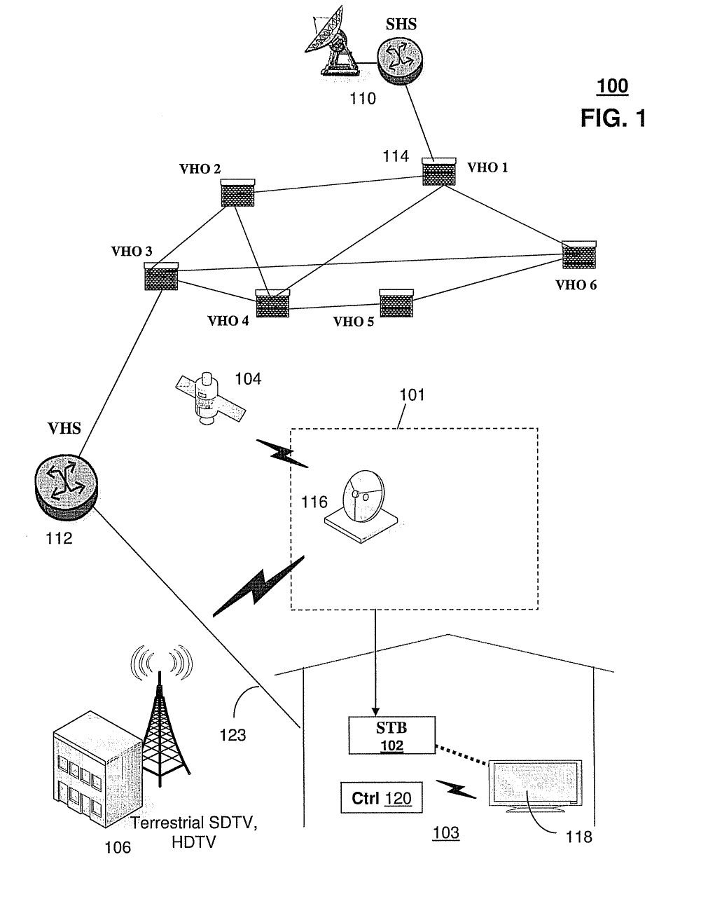

FIG. 1 depicts an exemplary embodiment of a communication system 100 having portions that can be configured for managing and presenting media content from one or more wireline and/or wireless media content providers received via a direct link 123 (e.g., fiber, coax cable, twisted pair wires, etc.) and/or an antenna system or assembly 101 for a structure or building 103, and transmitted to one or more set-top boxes (STBs) 102. In one embodiment, the antenna system 101 can be mounted to an exterior of the structure 103.

For example, digital television (DT) satellites 104 can be a part of a digital satellite television (DST) backbone for delivering media content. In one embodiment, the exterior antenna system 101 can have at least one low-noise block converter (LNB) 116 that distributes satellite broadcast signals to receivers, such as STBs 102. The STBs 102 in turn can present broadcast selections on media devices 118 such as display systems (e.g., computers, LCD or CRT monitors, and LCD or CRT televisions) or audio systems managed in some instances by a wired or wireless media controller 120 (e.g., infrared or RF remote controls). The present disclosure contemplates the use of other components and/or techniques for managing the received signals, including filters and amplifiers.

Alternatively or in combination therewith, the STB l 02 can receive multimedia broadcast channels from an Internet Protocol TV (IPTV) system coupled by cable 123 to the building 103. A super head office server (SHS) 110 can forward the media content to video head servers (VHS) 112 via a network of video head offices (VHO) 114 according to a common multicast communication method. The VHS 112 can then distribute multimedia broadcast programs to commercial and/or residential buildings 103, such as by cable. Unicast traffic can also be exchanged between the STBs 102 and the subsystems of the IPTV system for services such as video-on-demand (VoD).

The aforementioned DST system can also be combined or used in combination with terrestrial broadcast distribution systems to deliver television programming to STBs 102 within the structure 103 using wireless access technologies such as WiMAX. Although not shown, terrestrial broadcast systems can deliver content directly to the DST backbone, which in turn delivers the content via satellite 104 to the STBs 102. Alternatively or in combination therewith, a local broadcaster 106 can transmit local broadcast signals using any one of multiple local broadcast protocols. Such local broadcasts can be received by an element of the antenna system 101 configured to receive the local broadcasts, and the received signal can be distributed to the one or more STBs 102. For example, local broadcasters 106 transmitting television signals can encode their signals using NTSC, PAL or SECAM analog encoding protocols, ATSC, DVB-T, or ISDB-T digital encoding protocols, or next generation technologies as they arise. The local broadcasters 106 can modulate this signal onto a carrier wave to deliver standard definition (SDTV), high definition (HDTV) television broadcasts, or next generation broadcasts. However, the communications system 100 is not limited to the reception of television broadcasts, and the antenna system 101 can include multiple antenna elements to support other types of wireless communication technologies, including audio and data communications.

The antenna system 101 can be mounted at any point on the exterior of the structure 103. For example, the antenna system 101 can be mounted at an elevated point to enhance reception. In some instances, the multiple antenna elements of the antenna system 101 can include powered antenna elements, passive antenna elements, or any combination thereof. In some instances, a power supply can be directly provided at the antenna system 101 to power any powered antenna elements. However, the STB 102 can be configured to provide any necessary power via a coaxial antenna line, using techniques commonly used for providing power to LNBs of a DST system. For example, the power signal from the STB 102 can be configured to provide power to not only an LNB 116 of a satellite antenna element of the antenna system 101, but, as illustrated in FIG. 1, can also be used to power additional antenna elements.

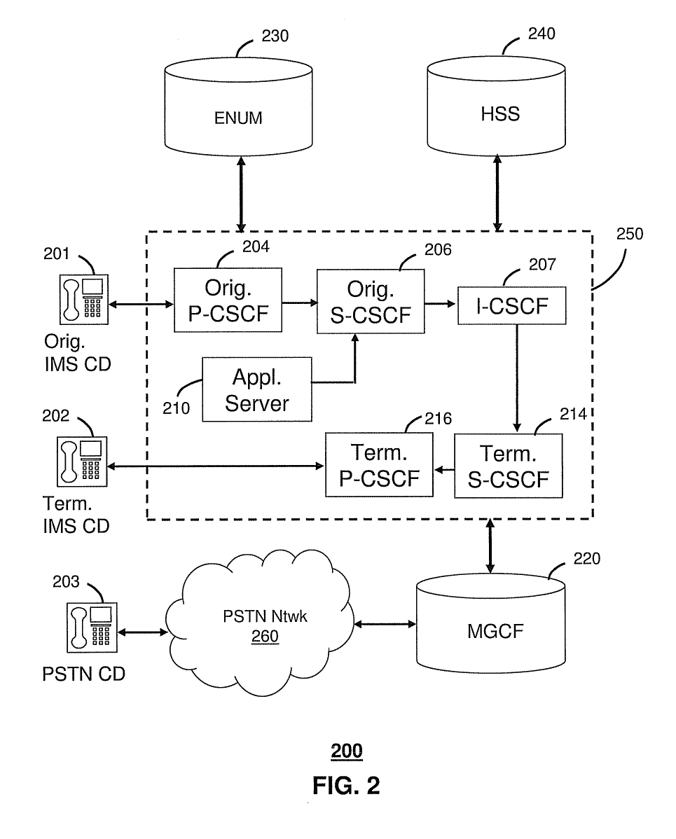

FIG. 2 depicts an exemplary embodiment of a communication system 200 employing a IP Multimedia Subsystem (IMS) network architecture. Communication system 200 can be overlaid or operably coupled with communication system 100 as another representative embodiment of communication system 100.

The communication 200 can comprise a Home Subscriber Server (HSS) 240, a tElephone NUmber Mapping (ENUM) server 230, and network elements of an IMS network 250. The IMS network 250 can be coupled to IMS compliant communication devices (CD) 201, 202 (e.g., set top boxes) or a Public Switched Telephone Network (PSTN) CD 203 using a Media Gateway Control Function (MGCF) 220 that connects the call through a common PSTN network 260. CDs 201-203 can be fixed, mobile, wireless and/or wired devices.

IMS CDs 201, 202 can register with the IMS network 250 by contacting a Proxy Call Session Control Function (P-CSCF) which communicates with a corresponding Serving CSCF (S-CSCF) to register the CDs with an Authentication, Authorization and Accounting (AAA) support by the HSS 240. To accomplish a communication session between CDs, an originating IMS CD 201 can submit a SIP INVITE message to an originating P-CSCF 204 which communicates with a corresponding originating S-CSCF 206. The originating S-CSCF 206 can submit the SIP INVITE message to an application server (AS) such as reference 210 that can provide a variety of services to IMS subscribers. For example, the application server 210 can be used to perform originating treatment functions on the calling party number received by the originating S-CSCF 206 in the SIP INVITE message.

Originating treatment functions can include determining whether the calling party number has international calling services, and/or is requesting special telephony features (e.g., *72 forward calls, *73 cancel call forwarding, *67 for caller ID blocking, and so on). Additionally, the originating SCSCF 206 can submit queries to the ENUM system 230 to translate an E.164 telephone number to a SIP Uniform Resource Identifier (URI) if the targeted communication device is IMS compliant. If the targeted communication device is a PSTN device, the ENUM system 230 will respond with an unsuccessful address resolution and the S-CSCF 206 will forward the call to the MGCF 220 via a Breakout Gateway Control Function (not shown).

When the ENUM server 230 returns a SIP URI, the SIP URI is used by an Interrogating CSCF (I-CSCF) 207 to submit a query to the HSS 240 to identify a terminating S-CSCF 214 associated with a terminating IMS CD such as reference 202. Once identified, the I-CSCF 207 can submit the SIP INVITE to the terminating S-CSCF 214 which can call on an application server similar to reference 210 to perform the originating treatment telephony functions described earlier. The terminating S-CSCF 214 can then identify a terminating P-CSCF 216 associated with the terminating CD 202. The P-CSCF 216 then signals the CD 202 to establish communications. The aforementioned process is symmetrical. Accordingly, the terms “originating” and “terminating” in FIG. 2 can be interchanged.

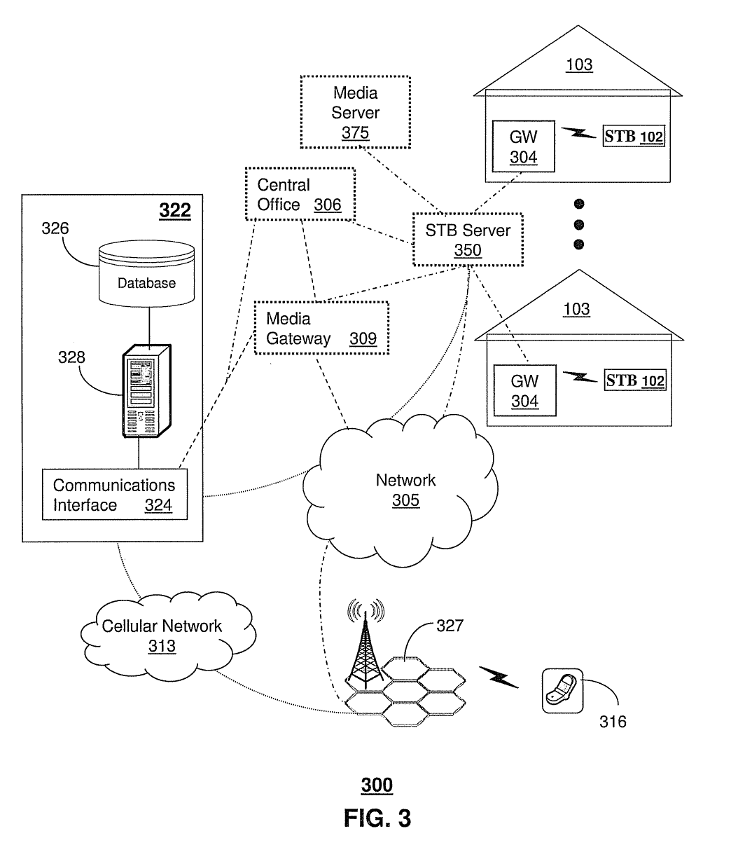

FIG. 3 depicts an exemplary embodiment of a communication system 300 employing set top box 102 communicating by way of wireless access points (WAPs) and/or wired infrastructure with an STB server 350 and/or a network proxy or web server 322, which collectively operate in the communication system 300. Communication system 300 can be overlaid or operably coupled with communication systems 100 and/or 200 as another representative embodiment of the communication system.

The set top boxes 102 can be multimedia devices for communicating video, voice and/or data, as well as receiving multimedia programming. The set top boxes 102 can include a tuner for receipt of the media programming, and a digital video recorder (DVR) or personal video recorder (PVR) for recording multimedia content. The set top box 102 can also include a memory device, such as a hard drive, for storage of various data, including multimedia content.

The set top boxes 102 can be multimode communication devices that can communicate via a number of modes of communication, including wired and/or wireless communication. The communication system 300 can comprise a packet-switched network 305. The packet-switched network can be an Internet Service Provider (ISP) network 305. The network 305 can be coupled to the network proxy 322, the cellular network 313 and network elements located in one or more of the buildings 103 representing an enterprise or residence. The ISP network 305 utilizes technology for transporting Internet traffic.

In an enterprise setting, the building 103 can include a gateway 304 that provides voice, video and/or data connectivity services between the set top boxes 102. In a residential setting, the building 103 can include a gateway 304 represented by, for example, a residential gateway coupled to central office 306 utilizing conventional telephonic switching for processing calls with third parties.

The network proxy 322 can be used to control operations of a media gateway 309, the central office 306 and the gateway 304. Communications between the network proxy 322, the set top boxes 102 and other network elements of the communication system 300 can conform to any number of signaling protocols such as a session initiation protocol (SIP), SS7, or a video communications protocol such as H.323 which combines video and voice over a packet-switched network, as well as cryptographic protocols, such as transport layer security (TLS) or secure sockets layer (SSL), to provide secure communications for data transfers.

The network proxy 322 can comprise a communications interface 324 that utilizes common technology for communicating over an IP interface with the network 305, the media gateway 309, the cellular network 313, and/or the gateway 304. By way of the communications interface 324, the network proxy 322 can direct by common means any of the foregoing network elements to establish packet switched data, voice, and/or video connections between the set top boxes 102 distributed throughout the communication system 300 and other communication devices, including STB server 350. The network proxy 322 can further comprise a memory 326 (such as a high capacity storage medium) embodied in this illustration as a database, and a controller 328 that makes use of computing technology such as a desktop computer, or scalable server for controlling operations of the network proxy 322. The network proxy 322 can operate as an IP Multimedia Subsystem (IMS) conforming in part to protocols defined by standards bodies such as 3GPP (Third Generation Partnership Protocol).

Under the control of the network proxy 322, the media gateway 309 can link packet-switched and circuit-switched technologies such as the cellular network 313 (or central office 306) and the network 305, such as an ISP network. The media gateway 309 can conform to a media gateway control protocol (MGCP) also known as H.248 defined by work groups in the Internet Engineering Task Force (IETF). This protocol can handle signaling and session management needed during a multimedia conference. The protocol defines a means of communication that converts data from the format required for a circuit-switched network to that required for a packet-switched network. MGCP can therefore be used to set up, maintain, and terminate calls between multiple disparate network elements of the communication system 300. The media gateway 309 can therefore support hybrid communication environments for the set top boxes 102, including VoIP terminals.

The central office 306 can house common network switching equipment for distributing local and long-distance telecommunication services supplied by network 305 to buildings 103 (such as dwellings or commercial enterprises). Telecommunication services of the central office 306 can include traditional POTS (Plain Old Telephone Service) and broadband services such as HDTV, DSL, VoIP (Voice over Internet Protocol), IPTV (Internet Protocol Television), Internet services, and so on. The communication system 300 can utilize common computing and communications technologies to support circuit-switched and/or packet-switched communications.

The cellular network 313 can support voice and data services over a number of access technologies such as GSM-GPRS, EDGE, CDMA-1X, UMTS, WiMAX, software defined radio (SDR), and other known and future technologies. The cellular network 313 can be coupled to base stations 327 under a frequency-reuse plan for communicating over-the-air with other communication devices of the communication system, including set top boxes 102.

The communication system 300 can include an STB server 350 that is in communication with one or more of the STBs 102 in the system. The STB server 350 can include various components, such as a controller, communications interface and memory, and can utilize various protocols for communication with the STBs 102, as well as with other communication or network devices of the communication system 300. The STB server 350 can be a separate device or sub-system of the communication system 300, or can be incorporated with other components of the communication system, such as being incorporated into the network proxy 322, including sharing one or more components with the network proxy. In one embodiment, the STB server 350 can communicate with one or more of the STBs 102 over the Internet.

The communication system 300 can include a media server 375 that is in communication with the STB server 350 and/or one or more of the STBs 102 in the system. In one embodiment, the media server 375 can store multimedia content that can be accessed (e.g., progressive download, full download, and/or streaming) by the STBs 102. In another embodiment, the media server 375 can search for, and provide access to, available multimedia content for an STB 102, such as by querying media databases over the Internet. The media server 375 can include various components, such as a controller, communications interface and memory, and can utilize various protocols for communication with the STB server 350 and/or the STBs 102, as well as with other communication or network devices of the communication system 300. The STB server 350 can be a separate device or sub-system of the communication system 300, or can be incorporated with other components of the communication system, such as being incorporated into the STB server 350 and/or the network proxy 322, including sharing one or more components with the network proxy.

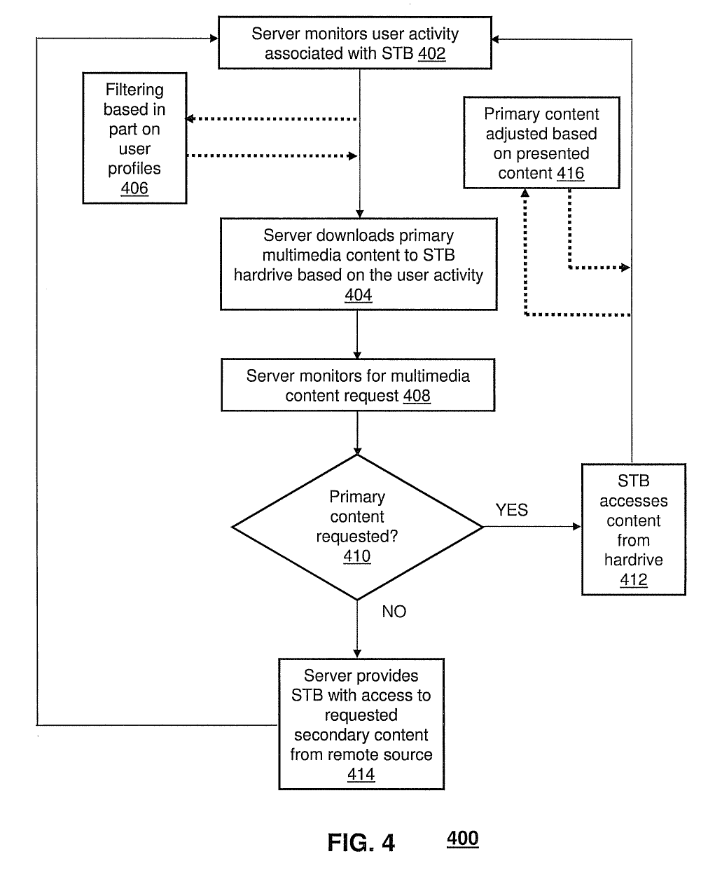

FIG. 4 depicts an exemplary method 400 operating in portions of the communication systems 100-300. Method 400 has variants as depicted by the dashed lines. It would be apparent to an artisan with ordinary skill in the art that other embodiments not depicted in FIG. 4 are possible without departing from the scope of the claims described below. For convenience, reference to one or more features of communication system 300 as used in the following paragraphs can mean one or more features of the communication systems 100, 200, and 300 singly or in combination.

Method 400 begins with step 402 in which the STB server 350 can monitor user activity associated with an STB 102. The user activity can include observed behavior, such as multimedia content that is being presented (e.g., during playback from a recording by a DVR, regularly scheduled programming, video-on-demand, etc.) and/or content that is scheduled to be recorded by the DVR of the STB 102. The user activity can include other criteria, such as a user's viewing duration. For example, the STB server 350 can monitor for programming that a user watches over its entire duration as compared to programming that the user watches for only a portion of the duration. The user activity can also be associated with one or more users of a STB 102, such as through use of user profiles that are required to activate use of the particular STB. In one embodiment, the STB server 350 can be a dedicated server that monitors the user activity associated with each of the STBs 102 throughout the communication system.

In step 404, the STB server 350 can filter out or otherwise determine primary multimedia content from available content (e.g., content stored in a media library of media server 375 or content selectively retrievable via query) based on the user activity, and download the primary multimedia content to the STB 102 for storage on the hardrive of the STB. As described above, the filtering can be based on user activity associated with the STB 102, and can be based on other criteria including pre-selections (e.g., genre, actors, new releases, and so forth). The particular time of the download can vary, and can be chosen based on a number of factors, including reduced activity of the STB 102 (e.g., early morning hours).

In one embodiment, the filtering out of primary multimedia content can be based on user profiles, as in step 406. For example, user profiles can be used to distinguish between the different users of a single STB 102, and the downloading of the primary multimedia content can be based on rules associated with the user profiles, including parental controls and amount of content for each user (e.g., a primary user can have a larger portion of content downloaded as compared to a secondary user).

The frequency of the filtering and/or downloading can vary. For example, the frequency of downloading of the primary multimedia content can be adjusted based on how often the user is accessing the primary content, as well as other factors, such as the amount of new content that has become available. The frequency of filtering and downloading and/or the factors for adjusting the frequency can also be selected by the user, such as in a user profile. For example, a user may desire daily downloading to ensure that the most up-to-date new releases are included in his or her primary multimedia content, along with other primary content determined based on his or her user activity.

In step 408, the STB server 350 can monitor for a request or other attempt to access multimedia content by the STB 102. In step 410, the STB server 350 can determine whether primary multimedia content is being requested by the STB. If the STB 102 is requesting access to the primary content then in step 412 the STB 102 can access and present the multimedia content which is stored on its hardrive. This provides a user with immediate access, which can be a higher quality content. The STB server 350 can then continue to monitor user activity associated with the STB 102 for filtering and downloading of the primary multimedia content, as recited back in steps 402 and 404.

If on the other hand, the STB 102 is not requesting access to the primary multimedia content but rather is requesting access to secondary multimedia content (i.e., content that was not filtered out and downloaded to the STB hardrive based on the user activity) then in step 414 the STB server 350 can provide the STB with access to the secondary content from a remote source. For example, the STB server 350 can provide or otherwise cause a streaming or progressive download of the secondary multimedia content by way of a broadband connection with the STB 102. The STB server 350 can then continue to monitor user activity associated with the STB 102 for filtering and downloading of the primary multimedia content, as recited back in steps 402 and 404. In one embodiment, the filtering and/or downloading of the primary multimedia content can be adjusted based upon the viewing of a primary multimedia content, as in step 416. For example, once a user watches a movie that was downloaded to his or her STB 102 as part of the primary multimedia content, the STB server 350 can replace that movie with some other content by way of download of the other content to the STB.

Upon reviewing the aforementioned embodiments, it would be evident to an artisan with ordinary skill in the art that said embodiments can be modified, reduced, or enhanced without departing from the scope and spirit of the claims described below. The multimedia content can be of various forms including video, music, still images, video games, and so forth. In one embodiment, the STB 102 can perform one or more of the steps described herein with respect to the STB server 350, such as the monitoring of the user activity. In another embodiment, the download or push of the primary multimedia content and the remote access or pull of the secondary content can be over the same mode of communication, such as IPTV, or can be over different modes of communication, such as downloading the primary content over a satellite TV system and providing access to the secondary content over a broadband connection. Other multimedia content transport combinations are also contemplated by the present disclosure including peer-to-peer (e.g., a group of STBs in communication over the Internet), Wi-Fi, and so forth.

Other factors, in addition to user activity, can be utilized to determine the primary multimedia content, including related content (e.g., sequels or continuations of programming) and whether the content is free. For example, a user can request, such as in a user profile, that priority be given to content that is free when determining the primary multimedia content. As another example, the user can provide other preferences with respect to the determination of the primary multimedia content. Such preferences can be included in the user's profile and/or can otherwise be provided by a user, such as in response to a notification that the primary content has been determined or is going to be downloaded.

These are but a few examples of modifications that can be applied to the present disclosure without departing from the scope of the claims. Accordingly, the reader is directed to the claims section for a fuller understanding of the breadth and scope of the present disclosure.

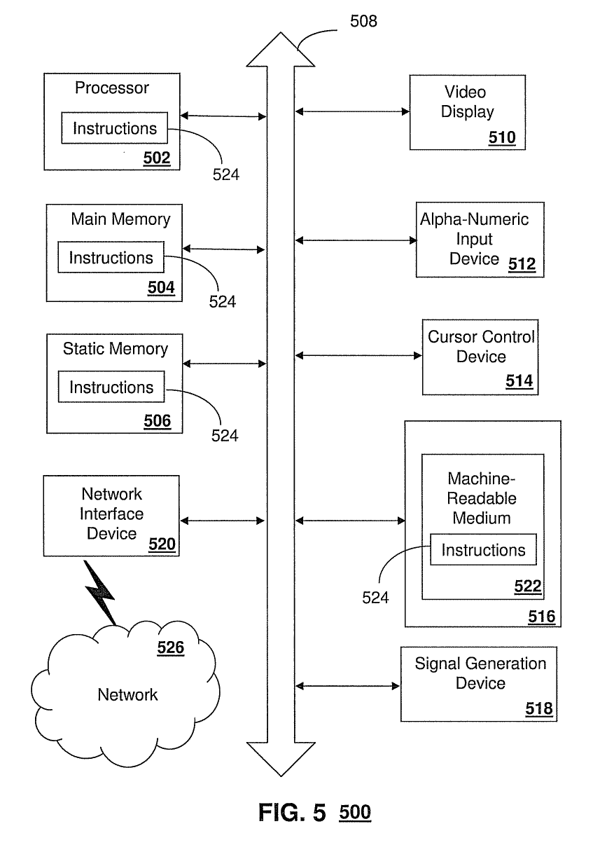

FIG. 5 depicts an exemplary diagrammatic representation of a machine in the form of a computer system 500 within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment.

The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. It will be understood that a device of the present disclosure includes broadly any electronic device that provides voice, video or data communication. Further, while a single machine is illustrated, the tern “machine” shall also be taken to include any collection of machines that individually or jointly execute a set (or multiple sets) of instructions to perform any one or more of the methodologies discussed herein.

The computer system 500 may include a processor 502 (e.g., a central processing unit (CPU), a graphics processing unit (GPU, or both), a main memory 504 and a static memory 506, which communicate with each other via a bus 508. The computer system 500 may further include a video display unit 510 (e.g., a liquid crystal display (LCD), a flat panel, a solid state display, or a cathode ray tube (CRT)). The computer system 500 may include an input device 512 (e.g., a keyboard), a cursor control device 514 (e.g., a mouse), a mass storage medium 516, a signal generation device 518 (e.g., a speaker or remote control) and a network interface device 520.

The mass storage medium 516 may include a computer-readable storage medium 522 on which is stored one or more sets of instructions (e.g., software 524) embodying any one or more of the methodologies or functions described herein, including those methods illustrated above. The computer-readable storage medium 522 can be an electromechanical medium such as a common disk drive, or a mass storage medium with no moving parts such as Flash or like non-volatile memories. The instructions 524 may also reside, completely or at least partially, within the main memory 504, the static memory 506, and/or within the processor 502 during execution thereof by the computer system 500. The main memory 504 and the processor 502 also may constitute computer-readable storage media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 524, or that which receives and executes instructions 524 from a propagated signal so that a device connected to a network environment 526 can send or receive voice, video or data, and to communicate over the network 526 using the instructions 524. The instructions 524 may further be transmitted or received over a network 526 via the network interface device 520.

While the computer-readable storage medium 522 is shown in an example embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure.

The term “computer-readable storage medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the disclosure is considered to include any one or more of a computer-readable storage medium or a distribution medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A computer-readable storage medium, comprising computer instructions for:
monitoring user activity associated with a set top box;
determining primary multimedia content and secondary multimedia content from available multimedia content based at least in part on the user activity;
transmitting the primary multimedia content to the set top box for storage therein; and
providing the set top box with selective access to the secondary multimedia content from a remote source.

2. The storage medium of claim 1, wherein the user activity is at least one among scheduled recordings, playback of recordings, and viewing of regularly scheduled programming.

3. The storage medium of claim 1, comprising computer instructions for:
transmitting the primary multimedia content to the set top box by way of a first mode of communication; and
providing the set top box with the access to the secondary multimedia content by way of a second mode of communication, wherein the first and second modes of communication utilize different communication protocols.

4. The storage medium of claim 1, comprising computer instructions for adjusting a time for the transmitting of the primary multimedia content to the set top box based at least in part on the user activity.

5. The storage medium of claim 1, comprising computer instructions for at least one of monitoring the user activity associated with the set top box based at least in part on a user profile for a user of the set top box and determining the primary multimedia content based at least in part on the user profile.

6. A server, comprising a controller to:
monitor user activity associated with a set top box;
determine primary multimedia content from available multimedia content based at least in part on the user activity; and
transmit the primary multimedia content to the set top box for storage therein.

7. The server of claim 6, wherein the user activity is at least one among scheduled recordings, playback of recordings, and viewing of regularly scheduled programming.

8. The server of claim 6, wherein the controller is adapted to:
determine secondary multimedia content from the available multimedia content; and
provide the set top box with selective access to the secondary multimedia content from a remote source.

9. The server of claim 8, wherein the controller is adapted to:
transmit the primary multimedia content to the set top box by way of a first mode of communication; and
provide the set top box with the access to the secondary multimedia content by way of a second mode of communication, wherein the first and second modes of communication utilize different communication protocols.

10. The server of claim 9, wherein the first mode of communication is satellite communication and the second mode of communication is broadband.

11. The server of claim 6, wherein the controller is adapted to adjust a time for the transmitting of the primary multimedia content to the set top box based at least in part on the user activity.

12. The server of claim 6, wherein the controller is adapted to monitor the user activity associated with the set top box based at least in part on a user profile for a user of the set top box.

13. The server of claim 6, wherein the controller is adapted to determine the primary multimedia content based at least in part on a user profile for a user of the set top box.

14. The server of claim 6, wherein the controller is adapted to receive from a user of the set top box a preference associated with the primary multimedia content, and wherein the determining of the primary multimedia content is based at least in part on the preference.

15. A set top box, comprising a controller to:
receive primary multimedia content from available multimedia content, wherein a determination of the primary multimedia content is based at least in part on monitored user activity associated with the set top box;
store the primary multimedia content; and
present the primary multimedia content in response to a request from a user.

16. The set top box of claim 15, wherein the controller is adapted to:
selectively access from a remote source secondary multimedia content from the available multimedia content; and
present the secondary multimedia content in response to a request from the user.

17. The set top box of claim 16, wherein the controller is adapted to:
receive the primary multimedia content by way of a first mode of communication; and
access the secondary multimedia content by way of a second mode of communication, wherein the first and second modes of communication utilize different communication protocols.

18. The set top box of claim 17, wherein the first mode of communication is satellite communication and the second mode of communication is broadband.

19. The set top box of claim 15, wherein a time for transmitting of the primary multimedia content to the set top box is based at least in part on the monitored user activity.

20. The set top box of claim 15, wherein the controller is adapted to receive a user profile associated with the user of the set top box, wherein the monitored user activity is based at least in part on the user profile.

21. The set top box of claim 15, wherein the determination of the primary multimedia content is based at least in part on a user profile for the user of the set top box.

22. The set top box of claim 15, wherein the controller is adapted to receive from the user of the set top box a preference associated with the primary multimedia content, and wherein the determination of the primary multimedia content is based at least in part on the preference.

23. A method, comprising:
monitoring user activity associated with a set top box;
determining primary and secondary multimedia content based at least in part on the user activity;
transmitting the primary multimedia content to the set top box for storage therein; and
providing the set top box with selective access to the secondary multimedia content from a remote source.

24. The method of claim 23, comprising:
transmitting the primary multimedia content to the set top box by way of a first mode of communication; and
providing the set top box with the access to the secondary multimedia content by way of a second mode of communication, wherein the first and second modes of communication utilize different communication protocols.

25. The method of claim 23, comprising:
monitoring the user activity associated with the set top box based at least in part on a user profile for a user of the set top box; and
determining the primary multimedia content based at least in part on the user profile.
